(19) United States
(12) Patent Application Publication
(10) Pub. No.: US 2026/0313063 A1
(43) Pub. Date: Oct. 8, 2026

(54) IMAGE FORMING APPARATUS, CONTROL METHOD FOR IMAGE FORMING APPARATUS, SERVER APPARATUS, CONTROL METHOD FOR SERVER APPARATUS, AND STORAGE MEDIUM

(71) Applicant: CANON KABUSHIKI KAISHA, Tokyo (JP)

(72) Inventor: YASUHIRO HOSODA, Kanagawa (JP)

(21) Appl. No.: 19/632,814

(22) Filed: Mar. 30, 2026

(30) Foreign Application Priority Data
Apr. 7, 2025 (JP) 2025-063357

(51) Int. Cl. H04N 1/44; H04L 9/30; H04L 9/32

(52) U.S. Cl. CPC H04N 1/4426; H04L 9/3073; H04L 9/3247; H04N 1/4433; H04N 2201/0094

(57) ABSTRACT

An image forming apparatus is provided. The image forming apparatus stores a public key and a user profile of a user in association with each other in a first memory, the public key being obtained from a terminal of the user and forming a pair with a private key held in the terminal, executes first authentication to authenticate the user by verifying, using the public key, a digital signature received from the terminal, and in a case where authentication of the user via the first authentication is successful, allows the user to log into the image forming apparatus using the user profile stored in association with the public key.

### BACKGROUND

### Field of the Technology

The technology of the present disclosure relates to technology for authenticating a user using a device, and in particular relates to an image forming apparatus, a control method for an image forming apparatus, a server apparatus, a control method for a server apparatus, and a storage medium.

### Description of the Related Art

In recent years, there are companies that centrally manage, with a server, the accounts of employees using Active Directory (registered trademark) from Microsoft or an LDAP server. With an image forming apparatus placed in an office of such a company, a user name and password managed by the server can be used to log into the image forming apparatus.

Also, increasingly there are companies that centrally manage the accounts of employees with a cloud server referred to as an Identity Provider (IdP) such as Microsoft Entra ID (formerly known as Azure Active Directory) from Microsoft and Google Workspace from Google. For example, an image forming apparatus in Japanese Patent Laid-Open No. 2024-7209 cooperates with an IdP and uses a user name, a password, and a one-time password to perform multi-factor authentication and authenticate a user who intends to use the image forming apparatus.

Recent known technology for authenticating a user includes FIDO 2.0 specified by the Fast Identity Online (FIDO) Alliance. With this technology, biometric authentication is performed on a terminal held by the user, and data signed using a private key via the terminal is verified on the authentication server side.

With image forming apparatuses, as proposed in Japanese Patent Laid-Open No. 2023-37169, FIDO authentication technology may be used so that an external service may be used from the image forming apparatus.

However, in order to log into an image forming apparatus using an account managed in a server, much effort is needed to input the user name and the password, making it not user-friendly. In recent years, for multi-factor authentication, input of a one-time password is also required, making it even less user-friendly.

In a login method for an image forming apparatus with good user-friendliness, an image forming apparatus provides authentication via an IC card or a similar employee ID card. However, there is the risk of IC cards being forged, and thus this method cannot be said to be sufficiently safe.

### SUMMARY

The technology of the present disclosure provides a method of logging into an image forming apparatus with both user-friendliness and safety.

One aspect of the present disclosure provides an image forming apparatus comprising: at least one memory storing instructions; and at least one processor that is in communication with the at least one memory and that, when executing the instructions, cooperates with the at least one memory to execute processing, the processing including storing a public key and a user profile of a user in association with each other in a first memory, the public key being obtained from a terminal of the user and forming a pair with a private key held in the terminal, executing first authentication to authenticate the user by verifying, using the public key, a digital signature received from the terminal, and in a case where authentication of the user via the first authentication is successful, allowing the user to log into the image forming apparatus using the user profile stored in association with the public key.

The configuration described above can provide a method of logging into an image forming apparatus with both user-friendliness and safety.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating a system configuration.

FIG. 2A is a diagram illustrating a hardware configuration of an MFP.

FIG. 2B is a diagram illustrating a hardware configuration of a mobile terminal.

FIG. 3 is a diagram illustrating a software configuration.

FIG. 4A is a diagram illustrating an example of a user database for local accounts.

FIG. 4B is a diagram illustrating an example of a role information table.

FIG. 4C is a diagram illustrating an example of a user profile table.

FIG. 5 is a diagram illustrating a user interface displayed on an operation panel of an MFP.

FIG. 6A is a diagram illustrating a user interface for login function settings.

FIG. 6B is a diagram illustrating a user interface for local account management.

FIG. 6C is a diagram illustrating a user interface for user account editing.

FIG. 7A is a diagram illustrating a user interface for authentication server settings relating to server accounts.

FIG. 7B is a diagram illustrating a user interface for passkey management of server accounts.

FIG. 8A is a diagram illustrating operation panel screen transitions at the time of password authentication.

FIG. 8B is a diagram illustrating operation panel screen transitions at the time of passkey registration.

FIG. 9 is a diagram illustrating a passkey registration sequence.

FIG. 10 is a diagram illustrating a passkey authentication sequence.

FIG. 11A is a diagram illustrating screen transitions at the time of passkey registration of a mobile terminal.

FIG. 11B is a diagram illustrating screen transitions at the time of passkey authentication of a mobile terminal.

FIG. 12 is a flowchart illustrating passkey registration processing.

FIG. 13 is a flowchart illustrating passkey authentication processing.

FIG. 14 is a flowchart illustrating user profile synchronization processing.

FIG. 15 is a diagram illustrating a system configuration according to a second embodiment.

FIG. 16 is a diagram illustrating a hardware configuration of a FIDO server.

FIG. 17 is a diagram illustrating a software configuration according to the second embodiment.

FIG. 18 is a diagram illustrating screen transitions of an operation panel according to the second embodiment.

FIG. 19 is a flowchart illustrating passkey registration processing according to the second embodiment.

FIG. 20 is a diagram illustrating screen transitions of a mobile terminal according to the second embodiment.

FIG. 21 is a flowchart illustrating passkey authentication processing according to the second embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### FIRST EMBODIMENT

In the present embodiment described below, a multi-function peripheral (MFP) provided with functions such as copy, print, and scan is used as an example of an image forming apparatus according to the present embodiment.

Note that in the present embodiment, as the authentication mechanism for the user to use a function or service provided by the image forming apparatus, digital signature verification technology such as Fast Identity Online (FIDO) is used. Specifically, the technology described in the present embodiment is related to a mechanism for authenticating a user by performing a biometric authentication on a mobile terminal (information processing apparatus) with a user and verifying the digital signature data output in response to authentication success on the image forming apparatus side. As described below, one advantage according to the present embodiment is that a digital function corresponding to a FIDO service using FIDO technology is incorporated into the image forming apparatus. Recently, FIDO authentication credential information is referred to as a passkey. The passkey information is constituted of a credential ID, a public key, a private key, and the like. The terminal of the user possesses the credential ID, the public key, and the private key as the passkey information. On the other hand, the FIDO-supporting server does not possess the private key and possesses the credential ID and the public key as the passkey information. FIDO is commonly known as a multi-factor authentication method with high safety that is resistant to phishing.

FIDO is given here as an example of such a mechanism, but it must be understood that the technology of the present disclosure is not limited to a standard specified by the FIDO Alliance. Also, the authentication on the mobile terminal is not limited to biometric authentication. For example, authentication of a knowledge element via a passcode or the like may be performed.

### System Configuration

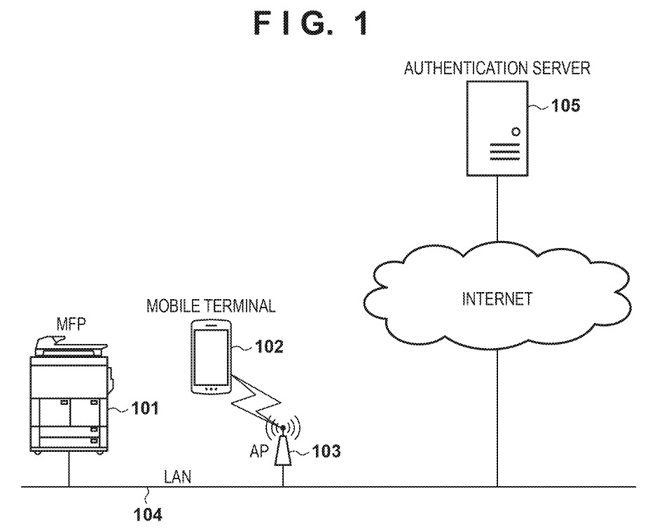

A system configuration according to the present embodiment will now be described with reference to FIG. 1. In the present embodiment, the MFP is expected to be placed in an office of a company. A mobile terminal 102 is a mobile terminal such as a smartphone. The mobile terminal may be a terminal installed with iOS from Apple, a terminal installed with Android (registered trademark) from Google, or the like. The mobile terminal 102 can communicate with an MFP 101 via an access point 103, a LAN 104, and the like of a wireless local area network (wireless LAN).

Also, in a case where the MFP 101 has a wireless LAN access point function, the mobile terminal 102 may be configured to connect to the wireless LAN access point function of the MFP 101 and communicate directly. Though not illustrated, in the office, a plurality of MFPs with the same configuration as the MFP 101 connected to the network may exist.

An authentication server 105 is a server for centrally managing the accounts of employees in the company. The authentication server 105 may be a virtual server established in the cloud connected via the Internet or may be an on-premises server directly connected to the LAN 104. As the authentication server 105 set on the Internet, Microsoft Entra ID from Microsoft, Google Workspace from Google, or a similar Identity Provider (IdP) can be used. Also, as the on-premises server directly connected to the LAN 104, Active Directory (registered trademark) from Microsoft, an open-source LDAP server, or the like can be used as the authentication server 105.

In the present embodiment examples described below, it is assumed that Microsoft Entra ID from Microsoft is used.

### Hardware Configuration of MFP 101

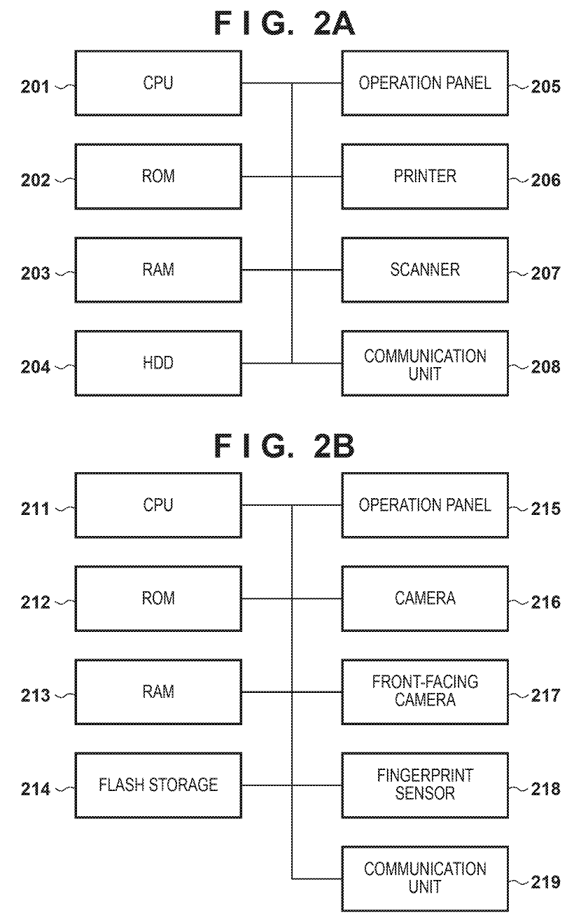

FIG. 2A is a simplified diagram illustrating the hardware configuration of the MFP 101. A CPU 201 is a central processing unit (processor) that controls all of the operations of the MFP 101. A random-access memory (RAM) 203 is a volatile memory and a working area and is used as a temporary storage area for loading various types of control programs stored in a read-only memory (ROM) 202 and a hard disk drive (HDD) 204.

The ROM 202 is non-volatile memory and stores a boot program of the MFP 101 and the like. The HDD 204 is a non-volatile hard disk or flash storage with a larger capacity than the RAM 203. Programs for controlling the MFP 101 are stored in the HDD 204. Also, the operating system (OS) and application programs are stored in the HDD 204.

When the MFP 101 is activated, the CPU 201 executes the boot program stored in the ROM 202. The boot program is configured to read out the OS program stored in the HDD 204 and load the program into the RAM 203. When the boot program is executed, the CPU 201 then executes the OS program loaded into the RAM 203 and executes control of the MFP 101. Also, the CPU 201 reads and writes, to and from the RAM 203, data used in operations of the control program.

Note that in this embodiment, in the MFP 101, a single CPU 201 executes the processing indicated in the following sequence diagram. However, in other embodiments, the MFP 101 may have a different configuration. For example, a configuration may be used in which a plurality of CPUs or microprocessors (MPU) cooperate to execute the processing indicated in the following sequence diagram. A portion of the processing described below may be executed using an application-specific integrated circuit (ASIC), a field-programmable gate array (FPGA), or a similar hardware circuit.

An operation panel 205 is a display (touch panel) on which a touch operation can be performed. A printer 206 is a printer engine that prints print data received from an external device via a communication unit 208 and digital data obtained from a scanner 207. The scanner 207 is a scanner apparatus that scans a paper document and converts it to digital data. The communication unit 208 is a network interface for connecting to the Internet, an office LAN, or the like.

### Hardware Configuration of Mobile Terminal 102

FIG. 2B is a simplified diagram illustrating the hardware configuration of the mobile terminal 102. A CPU 211 is a central processing unit (processor) that controls the entire operations of the mobile terminal 102. A RAM 213 is a volatile memory and a working area, and is used as a temporary storage area for loading various types of control programs stored in a ROM 212 and a flash storage 214.

The ROM 212 is non-volatile memory and stores a boot program of the mobile terminal 102 and the like. The flash storage 214 is a non-volatile memory storage with a larger capacity than the RAM 213. Programs for controlling the mobile terminal are stored in the flash storage 214. The OS and application programs are also stored in the flash storage 214.

An operation panel 215 is a display (touch panel) on which a touch operation can be performed.

A camera 216 is a camera module that can be used in photo and video capture and QR code (registered trademark) capture. A front-facing camera 217 is a camera that can be used in image capture of the user of the mobile terminal and facial authentication, which is one type of biometric authentication. A fingerprint sensor 218 is a sensor that can be used in fingerprint authentication, which is one type of biometric authentication. A communication unit 219 is a network interface for performing wireless communication.

### Hardware Configuration of Authentication Server 105

The authentication server 105 is constituted by a virtual server established in the cloud and a general-purpose computer such as a personal computer. The authentication server 105 includes a communication interface, a CPU, and a memory. The CPU executes a program loaded into the memory to receive authentication information, execute authentication processing, and respond with an authentication result. The details will not be described.

### Software Configuration

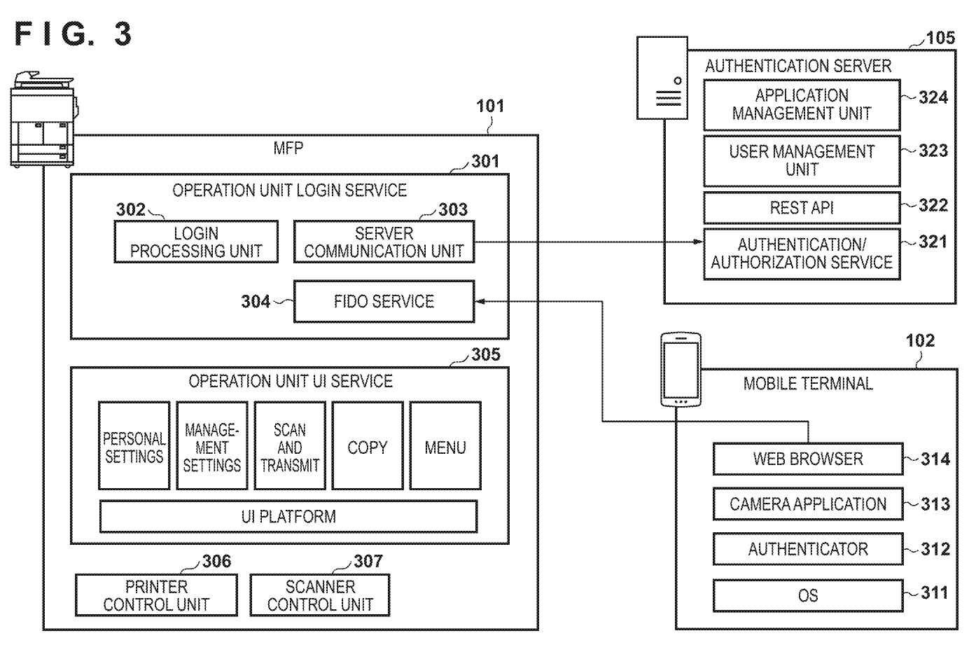

FIG. 3 is a simplified diagram illustrating the software configuration of the MFP 101 and the mobile terminal 102. The MFP 101 includes an operation unit login service 301 for authenticating the user using the MFP 101. The operation unit login service 301 includes a login processing unit 302, a server communication unit 303, and a FIDO service 304. The login processing unit 302 displays a login screen on the operation panel 205, authenticates the user based on the authentication information input via the operation panel, and logs the user into the operation panel. The server communication unit 303 has a function of communicating with a server such as the authentication server 105. The FIDO service 304 includes a web server function capable of communication using HyperText Transfer Protocol (HTTP). Also included is an authentication function such as WebAuthn (Web Authentication) specified by the FIDO Alliance or the World Wide Web Consortium (W3C).

An operation unit UI service 305 of the MFP 101 provides a user interface for providing functions to the user logged into the operation panel. The user interface provided by the operation unit UI service 305 includes a menu for the user to select a function, applications, a UI platform that controls screen transitions, and the like. Specifically, included are a “copy” application for providing the user with a copy function UI, a “print” application for providing a print function UI, a “scan and transmit” application for providing a UI for transmitting a scanned document externally, and the like.

A printer control unit 306 is a software module that controls the printer 206, and a scanner control unit 307 is a software module that controls the scanner 207. Each software module provides an application program interface (API) to the application for operating the printer 206 and the scanner 207. Though not illustrated, the software configuration of the MFP 101 may include driver software for controlling the operating system and various types of hardware.

### Mobile Terminal 102

An OS 311 of the mobile terminal 102 may be iOS from Apple, Android (registered trademark) from Google, or a similar OS installed in a terminal. An authenticator 312 is software with the FIDO authenticator function specified by the FIDO Alliance. The function of the authenticator 312 may be incorporated into the operating system as a function of the operating system (the OS 311). A camera application 313 is an application for controlling the camera 216 and the front-facing camera 217 to capture photos and video. A function for capturing and decoding QR codes may also be provided. A web browser 314 is software that runs as a client function performing HTTP communication. The web browser 314 may be Safari from Apple, Chrome from Google, Edge from Microsoft, or the like.

### Authentication Server 105

The authentication server 105 includes an authentication/authorization service 321, a REST API 322, a user management unit 323, an application management unit 324. The authentication/authorization service 321 includes a function of transmitting an HTML authentication screen to the client accessing the authentication server 105, obtaining the user name, password, and one-time password input, and authenticating the user. The authentication/authorization service 321 also includes a protocol function for OAuth 2.0, OpenID Connect, WS-Federation, SAML 2.0, or the like and authenticates clients and users trying to access using these protocols. The REST API 322 provides a Representational State Transfer (REST) API. For example, Microsoft Entra ID from Microsoft provides a REST API called Graph API, and information managed by the user management unit 323 can be accessed from the client using the REST API. The user management unit 323 manages information including the user name, password, email address, user permissions, and the like of a plurality of users. The application management unit 324 manages information including client IDs and secrets used in OAuth 2.0 or a similar protocol, application permissions, and the like. Also, as the transmission destination of an access token for OAuth 2.0, a redirect URL can be associated with a client ID and registered. It is expected that a client ID, a secret, and a redirect URL are pre-registered by the administrator of the authentication server 105 for receiving an OAuth 2.0 authentication/authorization request from the MFP 101 or a FIDO server 106 of a second embodiment.

### User Account

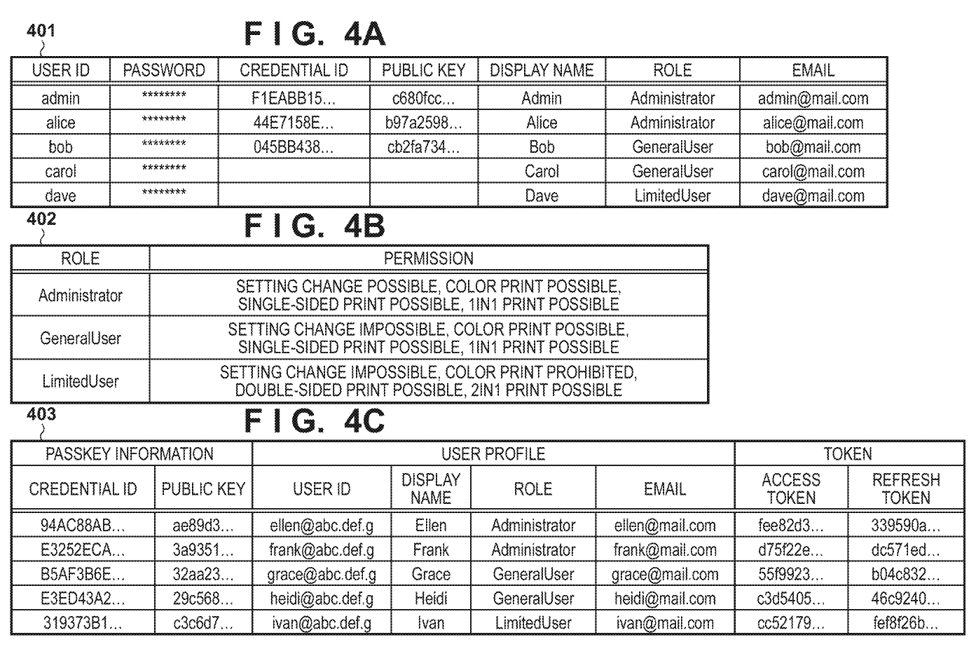

FIGS. 4A to 4C illustrate examples of data stored in the HDD 204 of the MFP 101. A user database 401 of FIG. 4A is a simplified diagram illustrating a user database for local accounts. The MFP 101 stores the user database 401 including user account information in the HDD 204 and manages the user database 401. Note that the database of another node on the network may be used after performing encryption and anti-falsification measures for the communication path and storage. In the user database 401, user ID, password, passkey information used in FIDO authentication (credential ID and public key), role, email address, and the like are stored. Note that the user database 401 includes items (user ID, display name, role, email address) corresponding to the user profiles included in a user profile table 403 described below. Accordingly, the user database 401 can also be referred to as a database storing user profiles.

“User ID” is an identifier or identification information for identifying a user. “Password” is the password used in authentication. “Public key” is a public key forming a pair with the private key held in the mobile terminal or the like owned by the user. “Role” is information indicating the use permission of the user for the MFP 101. An example of each role and use permission is indicated in a role information table 402 of FIG. 4B. The roles and permissions are associated together and registered in the role information table 402. In addition to the provided roles being defined from the time when the MFP 101 is shipped from the factory, the user may set detailed use permissions and create new roles. “Email” is the email address of the user.

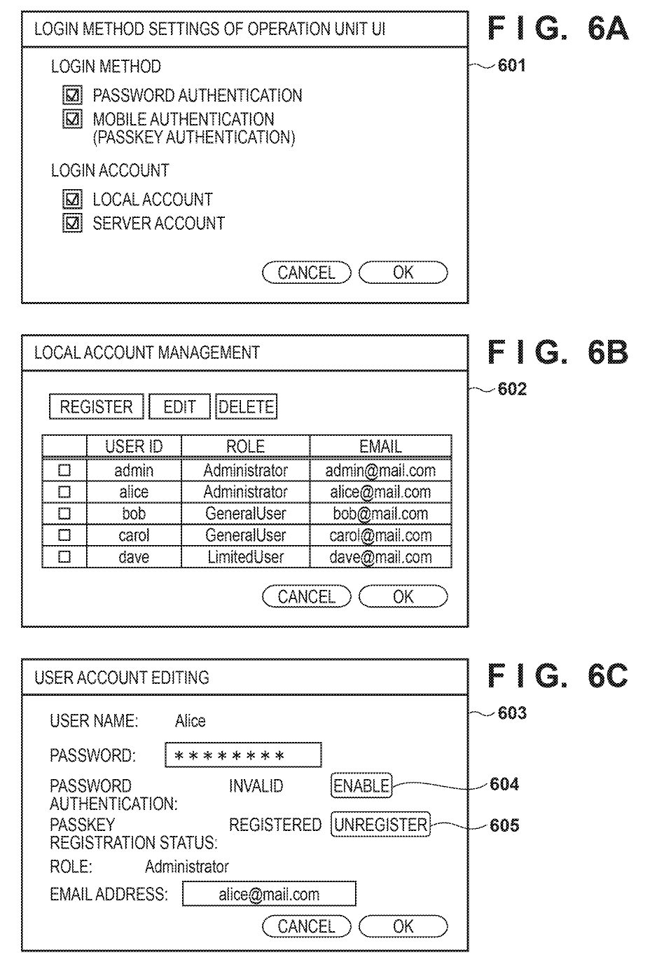

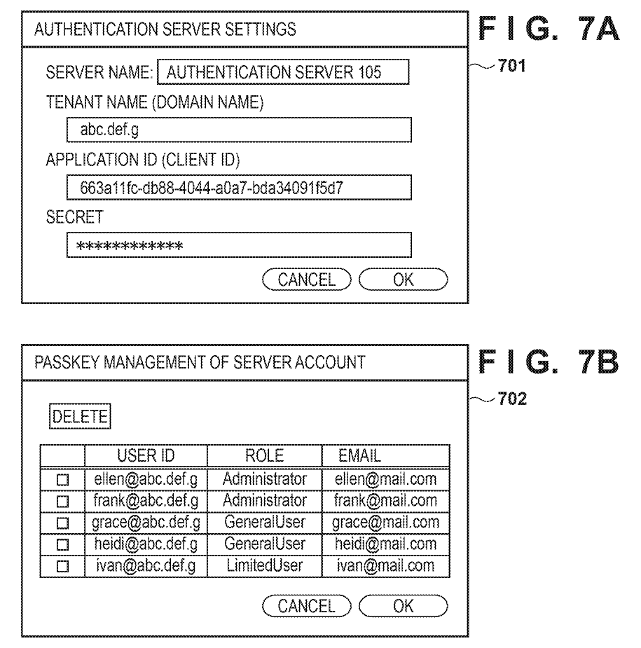

Registering, editing, and deleting the user account information is performed via the UI of a user account management screen 602 of FIG. 6B or a user account editing screen 603 of FIG. 6C described below. The user profile table 403 of FIG. 4C indicates a table in which passkey information, user profiles of server accounts, access tokens, and refresh tokens are associated together and stored. The passkey information includes a credential ID and a public key for each user. The user profile includes a user ID, display name, role, and email address for each user. The data of the user profile table 403 is stored in the HDD 204 via the flow of passkey registration described below. The registered data can be viewed or deleted via the UI of a passkey management screen 702 of a server account of FIG. 7B.

This data is read/written from the login processing unit 302, the server communication unit 303, and the FIDO service 304 of the operation unit login service 301.

### User Authentication Function

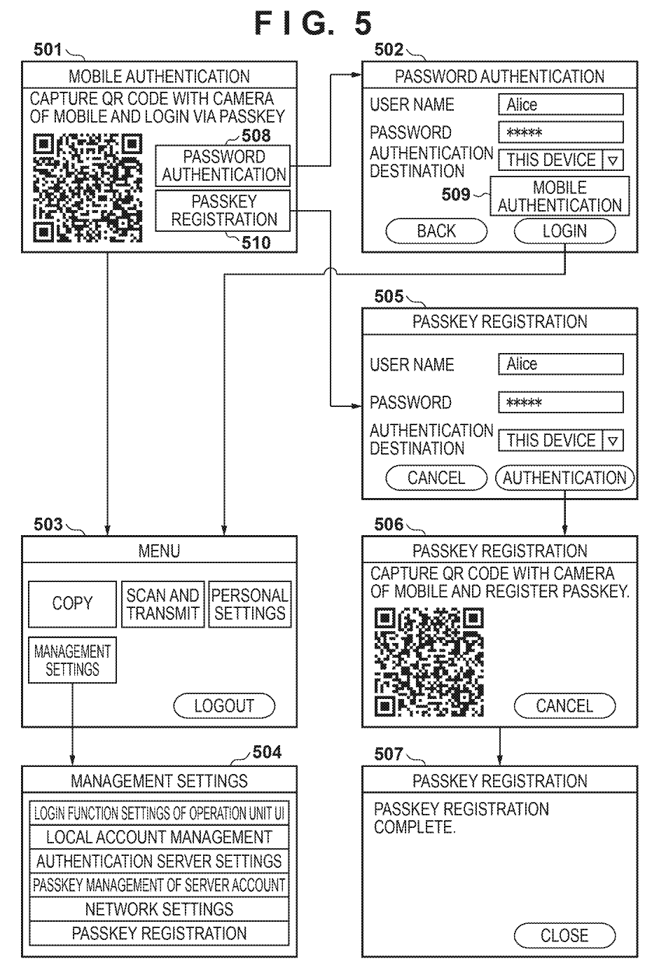

Next, the user authentication function provided in the MFP 101 will be described with reference to FIGS. 5, 6A to 6C, and 7A to 7B. Note that in the present embodiment, two types of user authentication will be described. The first is authentication using a password input by the user on the operation panel. The second is an operation unit login service 301 authenticating a user using technology using PKI specified by FIDO. In other words, with the latter, using the result of verification using a public key, signature data obtained by encrypting a challenge with a private key to authenticate a user is referred to as user authentication. Note that in the present embodiment, apart from such user authentication, authentication for authenticating the owner of a mobile terminal is performed with the mobile terminal. In this manner, in the present embodiment, a plurality of types of authentication exist.

FIG. 5 is a simplified diagram illustrating a login screen displayed on the operation panel 205 and menu screens displayed after login. FIGS. 6A to 6C are schematic views illustrating settings screens for setting the login method and performing user account management. FIGS. 7A to 7B are schematic views illustrating settings screens relating to cooperation between the MFP 101 and the authentication server 105. The screens illustrated in FIGS. 6A to 6C and 7A to 7B are displayed by a setting menu being selected from a management settings screen 504 illustrated in FIG. 5.

On a login method settings screen 601 of the operation unit UI illustrated in FIG. 6A, the login method when logging in on the operation panel can be selected. In the present embodiment, a user operation to select one or both options including “Password authentication” using a password input by the user and “Mobile authentication (passkey authentication)” using a passkey including a public key can be made receivable and enabled. Also, in a case where both methods are enabled on the login method settings screen 601, the login processing unit 302 may display a mobile authentication screen 501 and a password authentication screen 502 in a selectable manner. In the present embodiment, a password authentication button 508 is displayed on the mobile authentication screen 501, and selection of password authentication is received. Also, a mobile authentication button 509 is displayed on the password authentication screen 502, and selection of mobile authentication is received.

In a case where only mobile authentication is enabled in the login method settings screen 601 of the operation unit UI, the password authentication button 508 can be not displayed, and login can be made possible via only mobile authentication. In this manner, all users that wish to use the MFP 101 can be obligated to register a passkey. In a similar manner, in a case where only password authentication is enabled, the mobile authentication button 509 may be not displayed, and login can be made possible via only password authentication.

Also, on the login method settings screen 601 of the operation unit UI, an account to use to login can be selected. In a case where a local account is selected, login to the MFP 101 using an account stored in the user database 401 for local accounts illustrated in FIG. 4A is allowed. Also, in a case where a server account is selected, login using an account managed in the authentication server 105 is allowed. In the present embodiment, the authentication server 105 allows login to the MFP 101 using an account managed by the user management unit 323.

Password authentication provides a login method including inputting a user ID and a password. Specifically, the login processing unit 302 displays the password authentication screen 502 as a login screen on the operation panel 205. The user selects the “Authentication destination” pull-down menu and can select whether to use a “Local account” or use a “Server account”. “This device” in this diagram indicates using a local account. On the login method settings screen 601 of the operation unit UI, in a case where use of a server account is enabled, the server name and domain name are displayed as options in the “Authentication destination” pull-down menu. Note that Authentication destination indicates the entity that executes authentication processing, and where authentication is performed can be selected from the “Authentication destination” pull-down menu.

The user can input the user ID and password using physical keys provided on the MFP 101 or software keys (not illustrated). The login processing unit 302 receives the input of the user ID and password via the physical keys or software keys. In a case where the “Authentication destination” is “This device”, whether or not the user account information matching the received combination of user ID and password exists in the user database 401 is verified. In a case where matching user account information does exist, the user is logged in, and a post-login menu screen 503 is displayed.

Mobile authentication (passkey) is performed via cooperation between the login processing unit 302, the FIDO service 304, and the authenticator 312 of the mobile terminal 102. The user is authenticated via technology using a public key infrastructure (PKI) specified by FIDO referred to as a passkey. In a case where mobile authentication (passkey authentication) is enabled, the mobile authentication screen 501 is displayed on the operation panel 205 as the login screen, and the user is authenticated. Passkey registration and the authentication method using a passkey will be described below in detail. In a case where user authentication using password authentication or mobile authentication (passkey authentication) is successful, the login processing unit 302 logs the user into the operation panel 205.

When login is successful, the operation unit UI service 305 that detected the user login displays the menu screen 503 on the operation panel 205. Then, the operation unit UI service 305 provides the functions premised upon user authentication. In a case where a user allocated with the Administrator role has logged in, “Management settings” is made selectable from the menu screen 503, and a management settings screen 504 can be accessed to change the settings of the MFP 101. In a case where a user allocated with the GeneralUser role has logged in, control is performed to grey out the “Management settings” button of the menu screen 503 so that it cannot be selected.

When “Authentication server settings” is selected on the management settings screen 504, an authentication server settings screen 701 of FIG. 7A is displayed. The authentication server settings screen 701 of FIG. 7A is a screen for setting the information of the authentication server communicated with to authenticate a server account. For example, a server name, a tenant name (domain name), an application ID (client ID) used in the OAuth protocol, and a secret are registered. For example, with Microsoft Entra ID, a tenant name (domain name) for each company exists. Also, on the management screen of each tenant, an application used in the OAuth protocol can be registered, and a client ID and secret can be issued. Also, an address for the destination of transmission of an access token associated with a client ID can be registered as a redirect URL. By registering http://localhost/xxxx as the redirect URL, the terminal itself that ran the browser or WebView can be set as the access token reception destination.

When “Passkey management of server account” is selected on the management settings screen 504, the passkey management screen 702 of the server account of FIG. 7B is displayed. The passkey management screen 702 of the server account is a screen for viewing and deleting profile information of a server account stored in the HDD 204 in association with the passkey information.

In the case of authenticating a server account, the login processing unit 302 performs authentication using Authorization Code Grant of OAuth 2.0 and obtains an access token from the authentication server 105. The obtained access token is used to obtain the authenticated user profile from the authentication server 105. A user profile is basic information of a user including a user ID, display name, email address, and the like that correspond to an identifier for the user. Also, the “role”, which is the MFP use permission for the server account, is preferably determined based on the information included in the user profile obtained from the authentication server 105. For example, “Job information”, “Role information of authentication server 105”, “Affiliated user group”, “Affiliated organization information” and the like are obtained as the user profile, and the role as the use permission of the MFP may be determined based on this information. For example, a conversion rule to set management positions to an Administrator role and general employees to a GeneralUser role is preferably able to be preset.

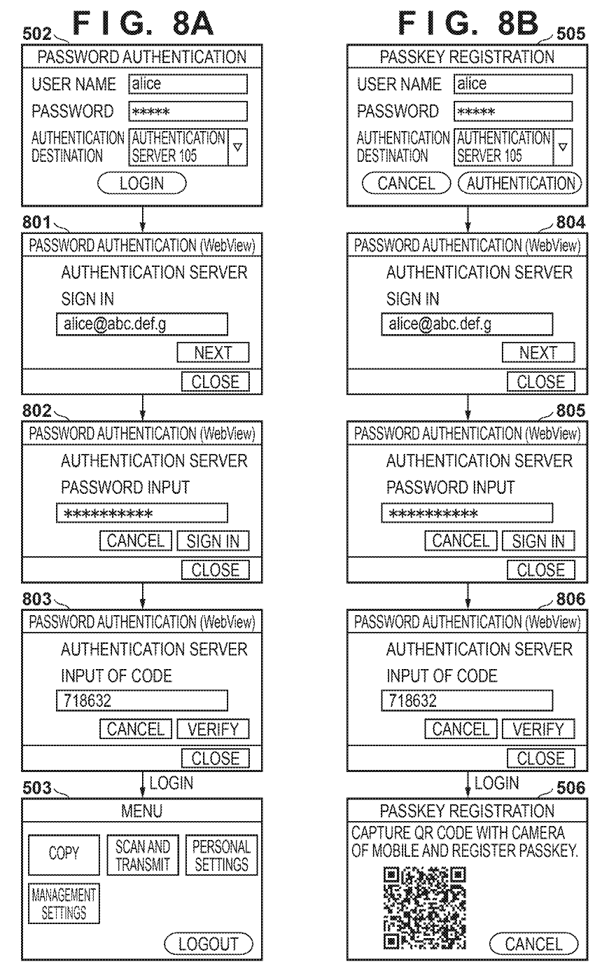

Screen transitions of the operation panel 205 when a server account is used at the time of password authentication will now be described with reference to FIG. 8A.

The login processing unit 302 uses a WebView function for authenticating/authorizing a user via Authorization Code Grant of OAuth 2.0. WebView is a component provided with a web browser function. Screens 801, 802, 803, 804, 805, and 806 of FIGS. 8A to 8B are screens configured in WebView for displaying the HTML screens obtained from the authentication server 105.

At the time of password authentication, the user selects “Authentication server 105” from the “Authentication destination” pull-down menu on the password authentication screen 502, inputs the user name and the password, and presses the login button. The login processing unit 302 displays the WebView screen 801, accesses the authentication server 105, and obtains and displays the HTML of the authentication screen from the authentication server 105. At this time, the login processing unit 302 preferably obtains the user name input on the password authentication screen 502 and automatically sets it on the screen 801. The user presses the “Next” button in a state in which the server account is input. Next, the WebView screen transitions to the screen 802, and input of the password is requested. The login processing unit 302 preferably obtain the password input on the password authentication screen 502 and automatically sets it on the screen 802. The user presses the “Sign in” button on the screen 802 in a state in which the password of the server account is input. When authentication of the password is successful, the next screen is transitioned to. In a case where multi-factor authentication is enabled for the server account, the WebView screen transitions to the screen 803, and input of a code is requested. The code is a one-time password specified in RFC6238 Time-based One-time Password (TOTP), for example. When the user inputs the code and presses the “Verify” button, the code is verified. In a case where verification of the code is successful, a screen (not illustrated) requesting the user for authorization may be displayed. When obtainment of an access token via Authorization Code Grant is successful, the access token is used to access the REST API provided by the authentication server and obtain the user profile. The login processing unit 302 logs the user into the MFP 101 using the obtained user profile and displays the menu screen 503. The login processing unit 302 transfers the user profile information to the operation unit UI service 305 and provides the MFP 101 with the information of the logged-in user.

As described above, with the MFP 101, the procedure for logging into the MFP 101 using the password of the server account managed by the authentication server 105 has many button press operations for text input and screen transitions, making it very troublesome for the user.

Screen transitions of the operation panel 205 when a server account is used at the time of passkey registration will now be described with reference to FIG. 8B. At the time of passkey registration, the user selects “Authentication server 105” from the “Authentication destination” pull-down menu on a passkey registration screen 505, inputs the user name and the password, and presses the authentication button. The login processing unit 302 displays the WebView screen 804 and authenticates the user. When user authentication via the screens 804 to 806 is successful and obtainment of an access token via Authorization Code Grant is successful, the access token is used to access the REST API provided by the authentication server and obtain the user profile. This may be the same as the description of the screens 801 to 803. Next, a passkey registration screen 506 including a display of a QR code is displayed. The QR code of the passkey registration screen 506 includes information of a URL for passkey registration provided by the FIDO service 304.

### FIDO Service Function

Next, the mechanism for passkey registration and passkey authentication using the FIDO service 304 will be described. The FIDO service 304 includes a web server function capable of communication using HTTP. Also included is an authentication function such as WebAuthn specified by the FIDO Alliance or the W3C.

The FIDO service 304 is accessed via HTTPS communication from the web browser 314 of the mobile terminal 102 that has captured the QR code displayed on the mobile authentication screen 501 or the passkey registration screen 506. The FIDO service 304 provides access to and functions of URL 1 to URL 6 as described below, for example, as a Web server.

### URL 1 https://mfp101.office.jp/registration/randomnumber

URL 1 is a URL indicating the location of the HTML for passkey registration. The HTML for passkey registration indicated by URL 1 includes JavaScript for accessing the REST API of URL 2 and URL 3 described below. Also, navigator.credentials.create, which is JavaScript for passkey generation specified by FIDO 2.0 is included. Also, the URL preferably can include a one-time random number. By including a random number, access can be restricted to access from a mobile terminal of a user in a position (in front of the MFP 101) where the QR code displayed on the passkey registration screen 506 can be captured.

### URL 2 https://mfp101.office.jp/registration/challenge

URL 2 is a URL of the REST API indicating the location of challenge data including a random number issued by the FIDO service 304. The challenge data is used in verification for passkey registration.

### URL 3 https://mfp101.office.jp/registration/verification

URL 3 is a URL of the REST API that receives information for passkey registration. The data for passkey registration includes a credential ID issued by the mobile terminal 102, a challenge, a public key, a digital signature, and the like.

### URL 4 https://mfp101.office.jp/authentication/randomnumber

URL 4 is a URL indicating the location of the HTML for passkey authentication. The HTML for passkey authentication indicated by URL 4 includes JavaScript for accessing the REST API of URL 5 and URL 6. Also, navigator.credentials.get, which is JavaScript for passkey authentication of WebAuthn specified by FIDO 2.0 is included. Also, the URL preferably can include a one-time random number.

### URL 5 https://mfp101.office.jp/authentication/challenge

URL 5 is a URL of the REST API indicating the location of challenge data including a random number issued by the FIDO service 304.

### URL 6 https://mfp101.office.jp/authentication/verification

URL 6 is a URL of the REST API that receives data for passkey authentication. The data for passkey authentication includes a credential ID of the passkey used in the digital signature, a challenge, a digital signature, and the like.

### Passkey Registration Sequence

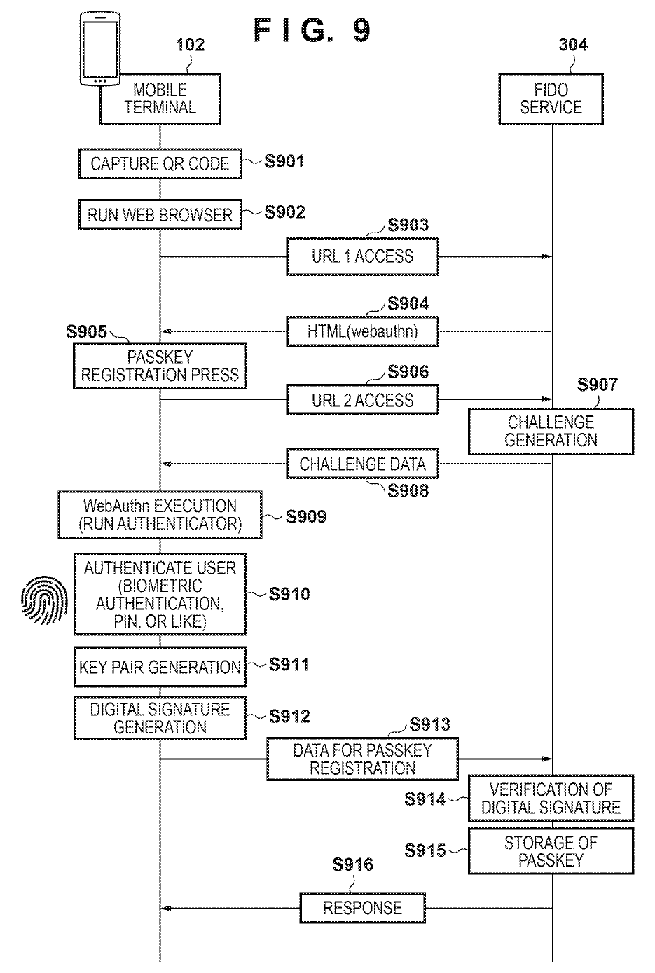

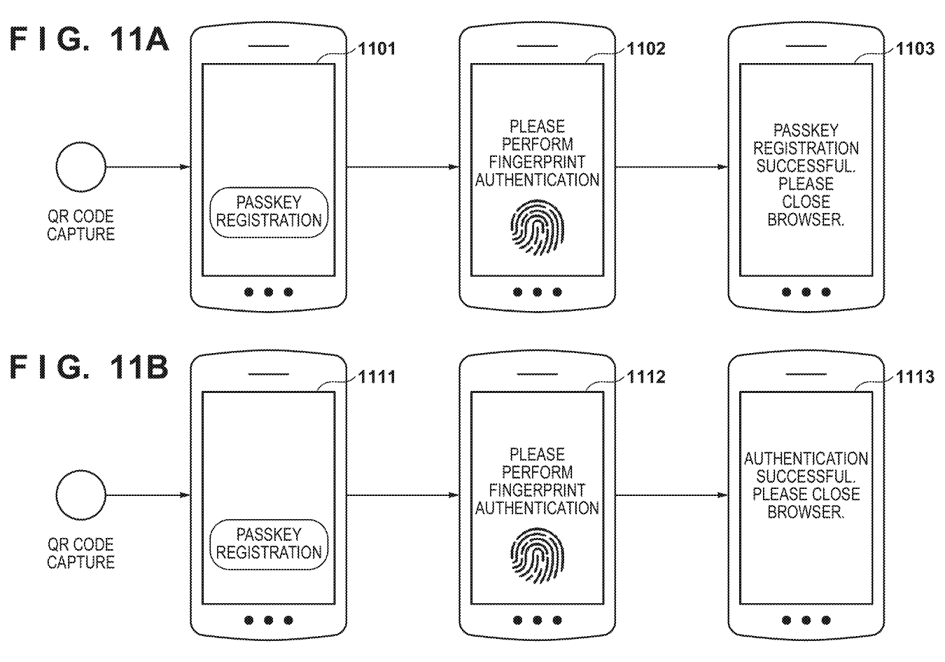

A sequence relating to passkey registration will now be described with reference to FIG. 9. FIG. 11A illustrates an example of an operation screen of the mobile terminal 102 at the time of passkey registration. In the procedure of FIG. 9, the operations of each step by the mobile terminal 102 are executed by the CPU 211 of the mobile terminal 102 in response to a user operation, a response from the FIDO service 304, and the like. The operations of each step by the FIDO service 304 are executed by the CPU 201 of the MFP 101 in response to the reception of data from the mobile terminal 102 and the like.

In S901, the user runs the camera application 313 from the mobile terminal 102 they own and captures the QR code displayed on the passkey registration screen 506. In other words, the mobile terminal 102 runs the camera application in accordance with a user operation and performs image capture in response to the user operation. At this time, the mobile terminal 102 may recognize the QR code included in the subject image and decode it.

Next, in S902, the camera application 313 runs the web browser 314. In this step, the mobile terminal 102 may run the web browser 314 in response to a URL being included in the QR code decoded in S901.

In S903, the web browser 314 accesses the address of URL 1 obtained from the QR code.

In S904, the FIDO service 304 responds with the HTML of a screen 1101 for passkey registration illustrated in FIG. 11A.

In S905, the mobile terminal 102 detects a press of the “Passkey registration” button of the screen 1101. The web browser 314 executes the JavaScript included in the HTML file received in S904 and accesses URL 2 in S906. Here, to remove the effort involved in the user pressing the “Passkey registration” button of S905, the JavaScript may be automatically executed to access URL 2. JavaScript can be automatically executed by using an onload event of JavaScript invoked at the timing when all of the HTML of the HTML screen 1101 is loaded into the web browser 314.

The FIDO service 304 that has received access to URL 2 performs challenge generation in S907. The challenge is a random number.

Next, in S908, the FIDO service 304 responds with challenge data including the generated challenge.

Next, in S909, the web browser 314 executes navigator.credentials.create, which is JavaScript of WebAuthn, using the received challenge data and runs the authenticator 312.

Next, in S910, the authenticator 312 performs authentication of the owner of the mobile terminal 102 via one of the methods including authentication using biological information such as facial authentication or fingerprint authentication, authentication using a passcode, pattern authentication, and the like. A screen 1102 of FIG. 11A is an example of a screen for prompting for fingerprint authentication.

Next, in S911, the authenticator 312 generates a key pair (PKI private key and public key pair) referred to as a passkey and a credential ID for identifying the passkey. Then, this is associated with the information (for example, mfp101.office.jp) of the server of the MFP 101 and a user ID and stored in a tampering-resistant storage area.

Next in S912, the authenticator 312 uses the generated private key and performs a digital signature on data including the challenge data received in S908. The authenticator 312 transmits the data for passkey registration to the web browser. The generated public key, the credential ID, the digital signature, and the like can be included in the data for passkey registration.

Next, in S913, the web browser 314 accesses URL 3 and transmits the data for passkey registration to the FIDO service 304.

Next, in S914, the FIDO service 304 verifies the digital signature using the challenge it issued in S907 and the received public key.

In a case where verification of the digital signature is successful, in S915, the FIDO service 304 stores the credential ID and the public key as passkey information. In S916, the FIDO service 304 responds with whether or not passkey registration was successful. The mobile terminal 102 that has received a response indicating that passkey registration was successful displays a screen, such as a screen 1103 of FIG. 11A, for showing the user this result in accordance with the success or failure of passkey registration.

### Passkey Authentication Sequence

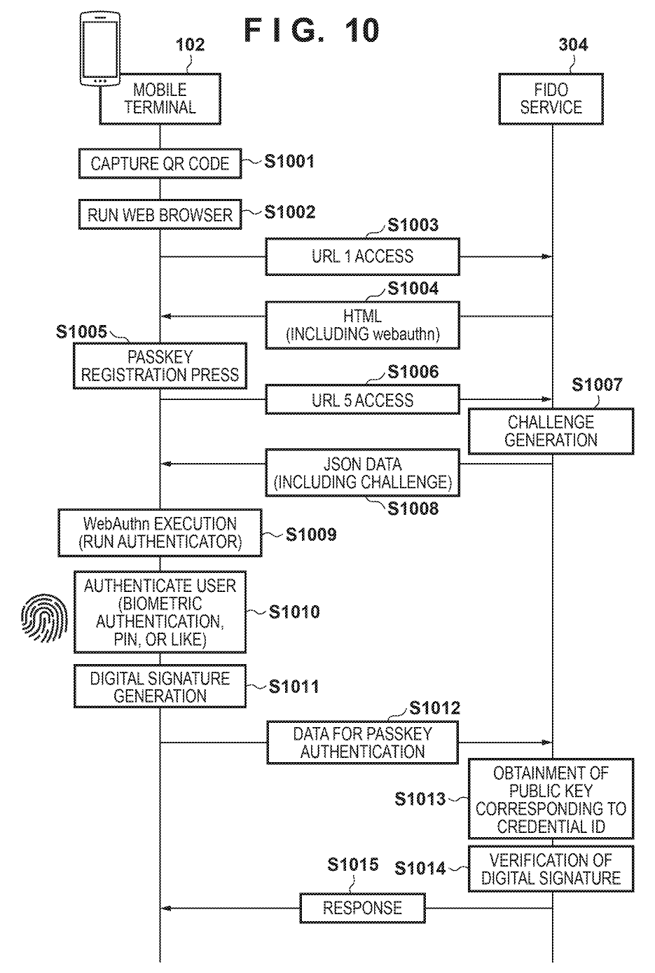

A sequence relating to passkey authentication will now be described with reference to the sequence diagram of FIG. 10. FIG. 11B illustrates an example of an operation screen of the mobile terminal 102 at the time of passkey authentication. In the procedure of FIG. 10, the operations of each step by the mobile terminal 102 are executed by the CPU 211 of the mobile terminal 102 in response to a user operation, a response from the FIDO service 304, and the like. The operations of each step by the FIDO service 304 are executed by the CPU 201 of the MFP 101 in response to the reception of data from the mobile terminal 102 and the like.

In S1001, the user runs the camera application 313 from the mobile terminal they own and captures the QR code displayed on the operation panel 205. In other words, the mobile terminal 102 runs the camera application in accordance with a user operation and performs image capture in response to the user operation. At this time, the mobile terminal 102 may perceive the QR code included in the subject image and decode it.

Next, in S1002, the camera application 313 runs the web browser 314. In this step, the mobile terminal 102 may run the web browser 314 in response to a URL being included in the QR code decoded in S1001.

Next, in S1003, the web browser 314 accesses the address of URL 4 obtained from the QR code.

In S1004, the FIDO service 304 responds with the HTML of a screen 1111 for passkey authentication illustrated in FIG. 11B.

In S1005, the mobile terminal 102 detects a press of the “Passkey authentication” button of the screen 1111. The web browser 314 executes the JavaScript included in the HTML file received in S1004 and accesses URL 5 in S1006. Here, to remove the effort involved in the user pressing the “Passkey authentication” button of S1005, the JavaScript may be automatically executed to access URL 5.

The FIDO service 304 that has received access to URL 5 performs challenge generation in S1007. The challenge is a random number.

Next, in S1008, the FIDO service 304 responds with challenge data including the generated challenge.

Next, in S1009, the web browser 314 executes navigator.credentials.get, which is the WebAuthn JavaScript described below, using the received challenge data and runs the authenticator 312.

Next, in S1010, the authenticator 312 performs authentication of the owner of the mobile terminal 102 via one of the authentication methods including facial authentication, fingerprint authentication, passcode, pattern authentication, and the like. A screen 1112 of FIG. 11B is an example of a screen for prompting for fingerprint authentication.

Next, in S1011, the authenticator 312 obtains the passkey (PKI private key) stored in association with the information (for example, mfp101.office.jp) of the server of the MFP 101. Then, a digital signature is generated using the private key in the data including the challenge received in S1008. The authenticator 312 transmits the data for passkey authentication to the web browser. The data for passkey authentication can include a digital signature, a credential ID of the passkey used in the digital signature, and the like.

Next, in S1012, the web browser 314 accesses URL 6 and transmits the data for passkey authentication to the FIDO service 304.

Next, in S1013, the FIDO service 304 obtains the public key associated with the received credential ID.

Next, in S1014, the digital signature included in the data for passkey authentication received in S1012 is verified using the “challenge it issued in S1007” and the “public key obtained from the HDD 204 in S1013”. In a case where verification of the digital signature is successful, authentication success is determined, and in a case where verification fails, authentication failure is determined.

Next, in S1015, the FIDO service 304 responds with whether or not authentication was a success or failure. The mobile terminal 102 that has received a response indicating that authentication was successful displays a screen, such as a screen 1113 of FIG. 11B, for showing the user this result in accordance with the success or failure of authentication.

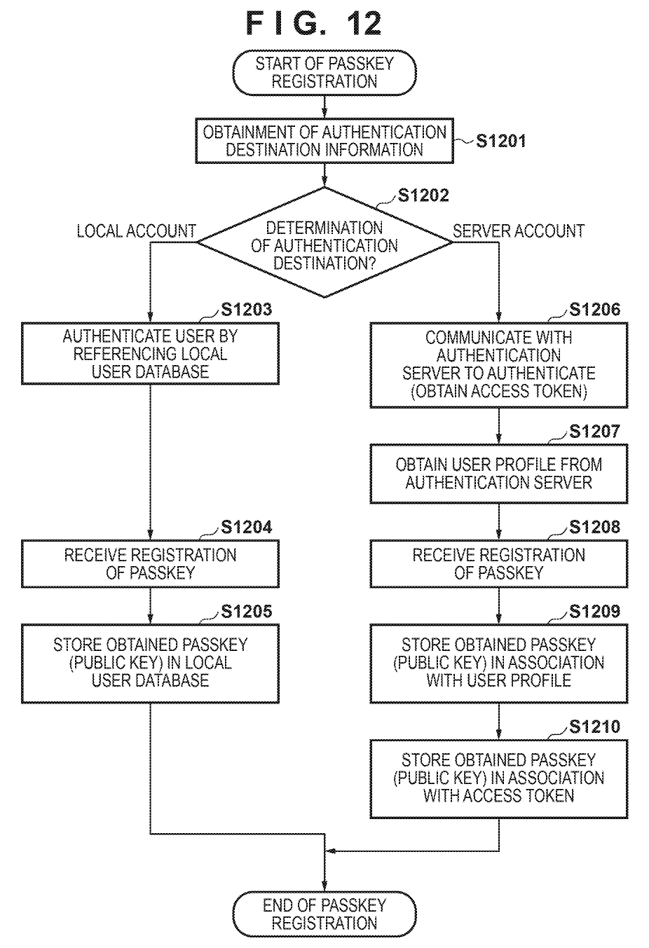

Next, the processing flow by the MFP 101 according to the present embodiment will be described with reference to FIGS. 12, 13, and 14. Note that in the present embodiment, the flow executed by the MFP 101 is stored in a software program of the login processing unit 302, the FIDO service 304, or the like. The software program is stored in a non-volatile storage such as the ROM 202, the HDD 204, or the like and is loaded into the RAM 203 for the flow to be executed by the CPU 201.

### Passkey Registration Flow

FIG. 12 is a flowchart illustrating the passkey registration processing. The login processing unit 302 displays the passkey registration screen 505 and starts the passkey registration processing.

In S1201, the login processing unit 302 obtains the authentication destination selected on the passkey registration screen 505. Next, in S1202, the login processing unit 302 determines whether the account which is the target of passkey registration is either a local account or a server account based on the authentication destination. In a case where the authentication destination is “This device”, it is determined to be a local account. In a case where the authentication destination is a server name or domain name, it is determined to be a server account.

In the case of a local account, in S1203, the login processing unit 302 references both the user name and password input on the passkey registration screen 505 and the user name and password registered in the user database 401 for local accounts illustrated in FIG. 4A. If both match, authentication is successful. If either one does not match, authentication is not successful. In this manner, users are authenticated.

In a case where authentication is successful, in S1204, the FIDO service 304 displays the passkey registration screen 506 including a QR code display and receives registration of a passkey. In a case where the sequence illustrated in FIG. 9 is executed and there is a passkey registration from the mobile terminal 102, the FIDO service 304 notifies the login processing unit 302 of the passkey information (credential ID and public key) obtained from the mobile terminal 102.

In S1205, the login processing unit 302 associates the passkey information (credential ID and public key) with the user authenticated in S1203 and stores this in the user database for local accounts. Note that as described above, the user database 401 includes items constituting a user profile in a similar manner to the user profile table 403. Thus, in S1205 also, a step in which the obtained passkey information is stored in association with a user profile can be performed.

In the case of a server account, in S1206, the login processing unit 302 displays the screens 801 to 803, performs communication with the authentication server 105, authenticates the user, and obtains an access token and a refresh token.

Next, in S1207, the login processing unit 302 performs communication with the authentication server 105 using the access token via the server communication unit 303 and obtains the user profile of the authenticated user.

When the user profile is successfully obtained, in S1208, the FIDO service 304 displays the passkey registration screen 506 including the QR code and receives registration of a passkey. In a case where the sequence illustrated in FIG. 9 is executed and there is a passkey registration from the mobile terminal 102, the FIDO service 304 notifies the login processing unit 302 of the passkey information (credential ID and public key) obtained from the mobile terminal 102.

In S1209, the login processing unit 302 associates the passkey information with the user profile obtained in S1207 and stores it in the HDD 204. The user profile to be stored may be the user profile obtained from the server unchanged or may be the information edited or converted to facilitate processing in the MFP 101. For example, as the user profile from the authentication server 105, if job information is included, the job information is converted to role information and stored or the like. For example, a conversion rule to set management positions to an Administrator role and general employees to a GeneralUser role is preferably able to be preset.

Further, in S1210, the login processing unit 302 preferably associates the access token and refresh token obtained in S1206 with the passkey (public key) and stores this.

When passkey registration is complete, the login processing unit 302 displays that passkey registration is complete on a screen 507 and ends processing.

The user profile of the server account stored in the HDD 204 can be viewed or deleted at any timing by the administrator of the MFP 101 via the passkey management screen 702 of the server account illustrated in FIG. 7B. In a case where the administrator selects the user profile and presses the “Delete” button on the passkey management screen 702 of the server account, the selected user profile or the like is deleted. The deleted information includes data such as the passkey information, the user profile stored in association with the passkey information, the access token, the refresh token, and the like, and this information is deleted from the HDD 204.

### Passkey Authentication Flow

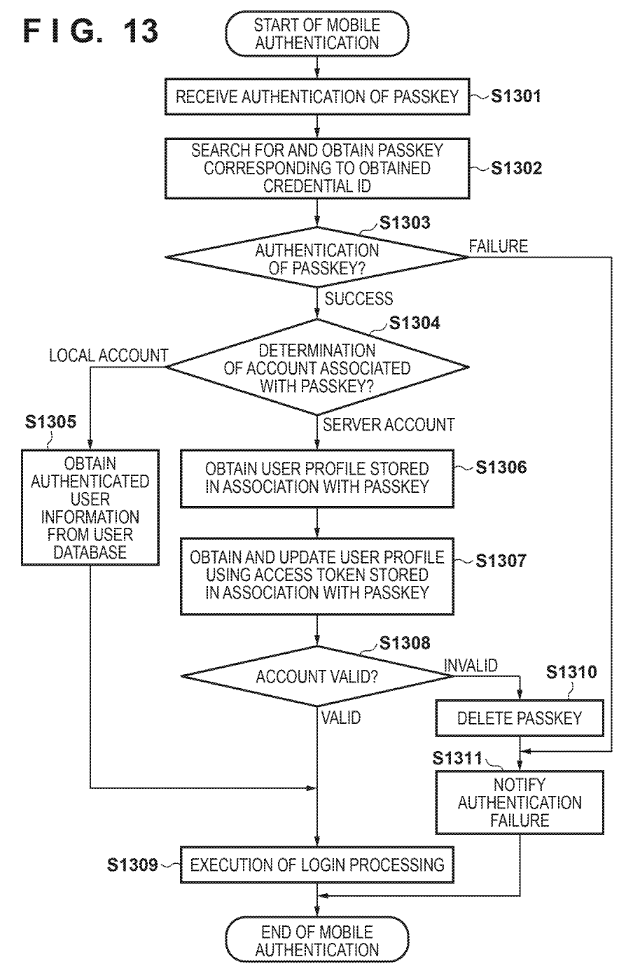

FIG. 13 is a flowchart illustrating the passkey authentication processing.

In S1301, the login processing unit 302 displays the mobile authentication screen 501 and receives the authentication of a passkey. The sequence illustrated in FIG. 10 is executed, and the FIDO service 304 receives the data for passkey authentication from the mobile terminal 102. When the credential ID included in the data for passkey authentication is obtained, in S1302, the FIDO service 304 searches for and obtains the public key corresponding to the credential ID from the HDD 204.

In S1303, the FIDO service 304 verifies the digital signature included in the data for passkey authentication using the public key obtained from the HDD 204 and determines whether or not verification was successful. In a case where verification was successful, passkey authentication is determined to be successful. In a case where obtainment of the public key is unsuccessful or verification of the digital signature is unsuccessful, passkey authentication is determined to be unsuccessful. In a case where it is determined that passkey authentication is unsuccessful, in S1311, that authentication was unsuccessful is displayed on the mobile authentication screen 501 and processing ends.

In a case where passkey authentication is successful, in S1304, the login processing unit 302 determines the type of the account that the obtained public key is associated with. In a case where the public key is found in the user database for local accounts illustrated in FIG. 4, it is determined to be a local account. In a case where the obtained public key is associated with a user profile obtained from the server, it is determined to be a server account.

In the case of a local account, in S1305, the login processing unit 302 obtains the user information that the public key is associated with from the user database for local accounts.

Next, in S1309, the login processing unit 302 executes login processing using the obtained user information, logs in the authenticated user to the MFP 101, and displays the menu screen 503.

In the case of a server account, in S1306, the login processing unit 302 obtains the user profile stored in association with the passkey.

Next, in S1307, the login processing unit 302 uses the access token and refresh token stored in association with the passkey information and connects to the authentication server 105 and attempts to obtain the latest user profile. In a case where obtainment of the latest user profile is successful, the stored user profile is updated with the new information.

In S1308, the login processing unit 302 determines whether or not the server account is valid. In a case where obtainment of the latest user profile from the authentication server 105 is successful and it can be confirmed that the server account is valid, it is determined that the server account is valid. In a case where the server account has been deleted from the authentication server 105 or it can be confirmed that the server account has been deactivated from the latest user profile, it is determined that the server account is invalid.

In a case where it is determined that the server account is valid, in S1309, the login processing unit 302 executes login processing using the user profile stored in association with the passkey information, logs in the authenticated user to the MFP 101, and displays the menu screen 503.

In a case where it is determined that the server account is invalid, in S1310, the login processing unit 302 deletes the stored passkey information and the user profile.

Furthermore, in S1311, the login processing unit 302 displays that authentication was unsuccessful on the mobile authentication screen 501 and ends the processing.

In the flow example described above, in S1307 and S1308, confirmation is performed relating to obtainment of the latest user profile of the authentication server 105 and the validity of the server account. However, this processing may be omitted, and in S1306, if a user profile stored in association with the passkey information can be found, this user profile may be used to execute the login processing of S1309.

As another method of updating the user profile stored in association with the passkey information, the following method is effective.

### User Profile Synchronization Flow

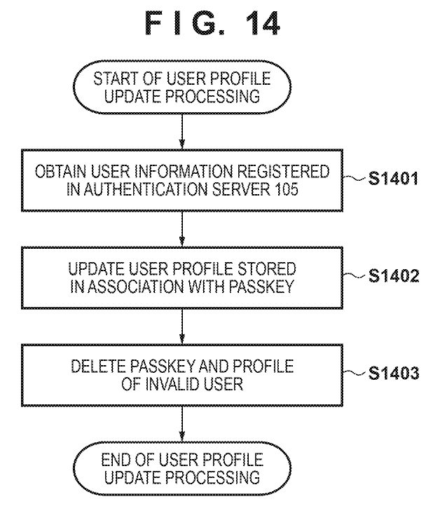

FIG. 14 is a flowchart illustrating a processing flow for synchronizing “a user profile stored in association with the passkey information” and “a user profile of the authentication server 105”. The processing of FIG. 14 is implemented by the CPU 201 of the MFP 101 executing a program loaded into the RAM 203. However, in the description, the software modules of FIG. 3 and in particular the server communication unit 303 is the executing entity. The processing of FIG. 14 may be periodically executed, for example.

The server communication unit 303 of the MFP 101 starts a user profile update processing task at a predetermined time. The task may be a task executed at a predetermined date and time or a task executed periodically such as once every 24 hours.

When the processing starts, in S1401, the server communication unit 303 accesses the authentication server 105 and obtains the user profiles of a plurality of server accounts managed by the authentication server 105. For example, in a case where the authentication server 105 uses Microsoft Entra ID, using the credentials (client ID, secret, digital signature, and the like) of the application stored in the MFP 101 in advance, a Client Credential Grant of OAuth 2.0 can be used to obtain an access token. Also, in the settings on the Microsoft Entra ID side, if the access privilege for the user information associated with the client ID is provided, the access token can be used to obtain the user profiles of a plurality of server accounts. Also, in a case where the authentication server 105 uses Google Workspace, a mechanism for an account with privileges called a service account is prepared and an access token can be obtained using the credential information of the service account.

Next, in S1402, the server communication unit 303 compares the user profiles of the plurality of server accounts obtained in S1401 and the user profile stored in association with the passkey information. In a case where there is an update to the information, the user profile is updated with the new information.

Next, in S1403, in a case where the server communication unit 303 learns from the information obtained in S1401 that the server account has been deleted or is invalid, the server communication unit 303 deletes the corresponding user profile.

In this manner, a user profile stored in the MFP 101 in association with the passkey information can be synchronized with the user profile of the authentication server 105.

### Effect of Present Embodiment

As described above in the first embodiment, the procedure for logging into the MFP 101 using the password of the server account includes many button press operations for text input and screen transitions, making it very troublesome for the user. However, by obtaining the user profile required for logging into the MFP from the authentication server and storing the user profile together with the passkey information, authentication using a password can be replaced by passkey authentication.

As described in the present embodiment, with passkey authentication, authentication can be performed on the mobile terminal of the user using a procedure including only capturing a QR code and performing biometric authentication, thus allowing the effort of button pressing and the like to be reduced as much as possible. Since passkey is multi-factor authentication with high safety that is resistant to phishing, user-friendliness is enhanced without a reduction in safety.

In the present embodiment, a FIDO service is configured separate from the authentication server. Thus, even in a case where the authentication server used by the user does not support the FIDO server, only the FIDO mechanism can be used.

Also, passkey information is configured to be stored in the MFP instead of the authentication server. Thus, there is no need for the authentication server to have a passkey registration function.

Also, typically, even if the authentication server has a FIDO service function and the capability to execute passkey authentication, there is no guarantee that it is operated to use passkey authentication. In the present embodiment, the login method setting of the operation unit UI of the MFP can be restricted to only mobile authentication (passkey authentication). Thus, even if operations using the passkey are not performed on the authentication server side, use of the passkey can be made compulsory for logging into the MFP.

Processing for updating a user profile stored in the MFP taking into account the server account information being updated, deleted/invalid, and the like on the authentication server side has also been described.

### SECOND EMBODIMENT

In the first embodiment described above, the image forming apparatus includes digital signature verification technology (FIDO service) in the device. In this example, in a case where a plurality of image forming apparatuses are placed in an office and users use the plurality of image forming apparatuses, passkey information (public key and the like) needs to be registered in each image forming apparatus. As an embodiment to solve this problem, in the second embodiment described below, the digital signature verification technology (FIDO service) is configured to be outside of the image forming apparatus. In the second embodiment, a user using an image forming apparatus is authenticated using the digital signature verification technology (FIDO service) configured externally.

### System Configuration

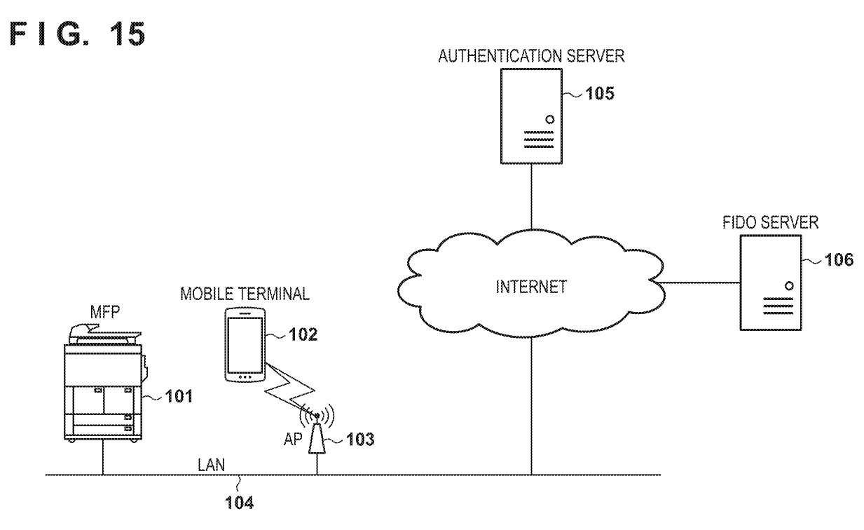

A system configuration according to the present embodiment example will now be described with reference to FIG. 15. The MFP 101, the mobile terminal 102, the authentication server 105, and the connection method are similar to that of the first embodiment. In addition to this, in the second embodiment, the FIDO server 106 is connected via a network. The FIDO server 106 may be a virtual server established in the cloud connected via the Internet or may be an on-premises server connected to the LAN 104. Though not illustrated, in the office, a plurality of MFPs with the same configuration as the MFP 101 connected to the network may exist.

### Hardware Configuration

The hardware configuration of the MFP 101 is similar to the configuration illustrated in FIG. 2A of the first embodiment. The hardware configuration of the mobile terminal 102 is similar to the configuration illustrated in FIG. 2B of the first embodiment.

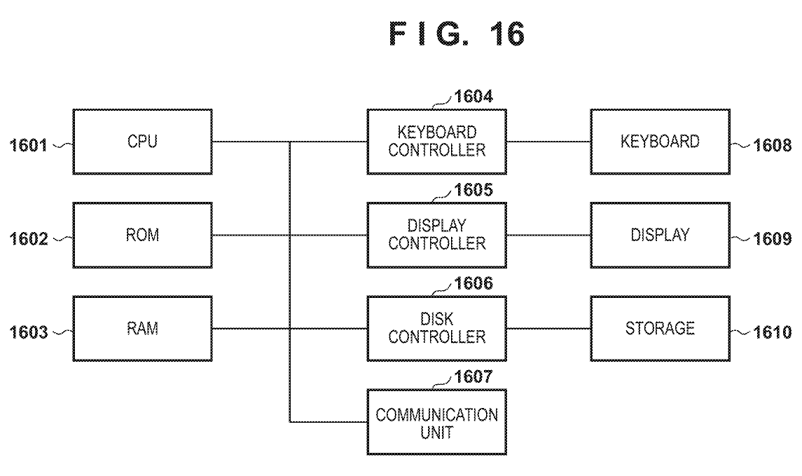

FIG. 16 is a simplified diagram illustrating the hardware configuration of a general-purpose computer for implementing the FIDO server 106.

A CPU 1601 executes programs stored in a ROM 1602 and programs such as the operating system (OS) and applications loaded into a RAM 1603 from an external storage 1610. In other words, the CPU 1601 functions as the processing units that execute each sequence described below by executing programs stored in a readable storage medium. The RAM 1603 is a main memory of the CPU 1601 and functions as the working area and the like. A keyboard controller 1604 controls the operation input from a keyboard 1608 or a non-illustrated pointing device (mouse, touchpad, touch panel, trackball, or the like). A display controller 1605 controls the display of a display 1609. A disk controller 1606 controls disk access to a storage 1610 such as a hard disk (HDD) or a flash memory that stores various types of data. A communication unit 1607 is connected to a network and is a network interface that executes communication control processing with other devices connected to the network. In a case where the server is established as a virtual server, since operations are performed remotely, the keyboard 1608 and the display 1609 are not necessarily required. Also, instead of the storage 1610, a storage that supports a network that can communicate with the communication unit 1607 may be used.

### Software Configuration

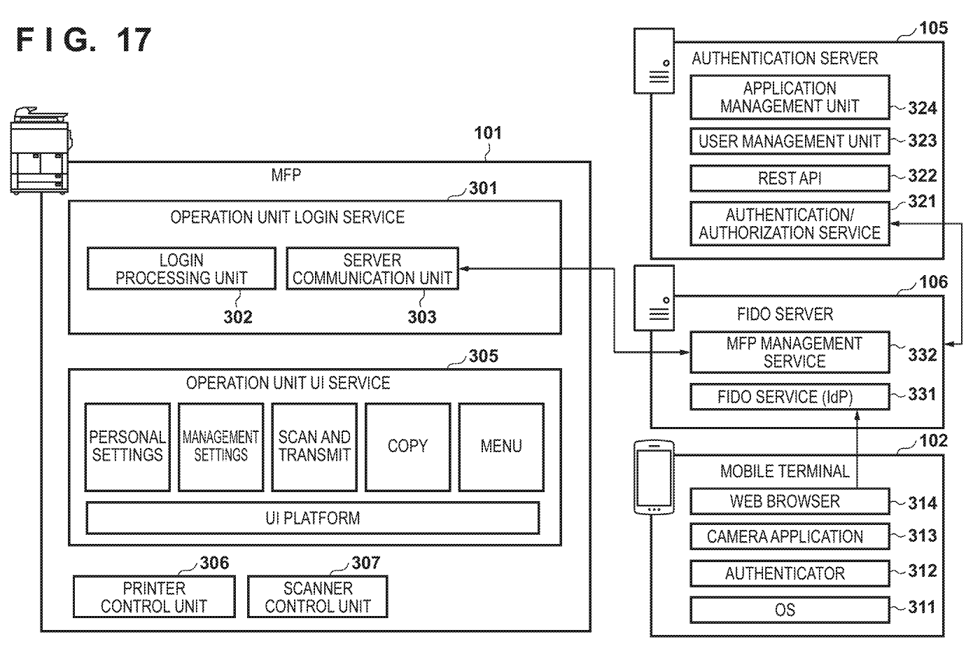

FIG. 17 is a simplified diagram illustrating the software configuration of the MFP 101, the mobile terminal 102, the authentication server 105, and the FIDO server 106. Software modules that are the same as the software modules illustrated in FIG. 3 of the first embodiment are given the same reference number and are not described.

The operation unit login service 301 communicates with the FIDO server 106 via the server communication unit 303 instead of the FIDO service 304 illustrated in FIG. 3.

The server communication unit 303 receives messages from the FIDO server 106, and thus establishes a WebSocket connection with an MFP management service 332 of the FIDO server 106. The connection with the MFP management service 332 is not limited to using WebSocket, and any technology may be used that enables messages to be transmitted from the FIDO server 106 to the MFP. For example, other technology such as Message Queue Telemetry Transport (MQTT), long polling, WebPush, and the like may be used.

The MFP management service 332 of the FIDO server 106 can manage the information of a plurality of MFPs that are connected to the FIDO server 106. The MFP management service 332 authenticates the plurality of MFPs connected to the FIDO server 106 using client certificate technology or the like. Also, IDs for identifying MFPs from the server communication unit 303 are received, and connections between the FIDO server 106 and the MFPs are managed.

A FIDO service 331 includes a web server function capable of communication using HTTP. Also included is an authentication function such as WebAuthn specified by the FIDO Alliance or the W3C. Also, the FIDO service 331 is provided with a website for the administrator of the FIDO server 106 to set settings. For example, in order to register information for cooperating with the authentication server 105, as with the screen 701, a website for registering information such as the server name, the tenant name (domain name), the application ID, and a secret is included. Also, the FIDO service 331 stores the user profile obtained from the authentication server 105 in association with the passkey information. Accordingly, a website similar to the screen 702 is provided for viewing and deleting a database for storing information similar to that of the user profile table 403, stored passkey information, and user profiles.

The MFP management service 332 is provided with a website or database for registering or managing MFPs that connect to the FIDO server 106.

The FIDO server 106 may be provided with a function of managing MFPs of each office on a tenant basis based on a contract with the company office, passkey information of MFP users, and profiles. In this case, only users with permission on a tenant basis can perform registration in the authentication server 105 and manage MFPs and the passkey and profile of MFP users on a website of the FIDO server 106.

To simplify the description, the MFP 101 according to the present embodiment is configured so that in the login method settings screen 601 of the operation unit UI, only “Mobile authentication (passkey authentication)” is selected, and “Password authentication” is set to OFF. Also, only “Server account” is selected for the login account, and the setting for using a local account is set to OFF.

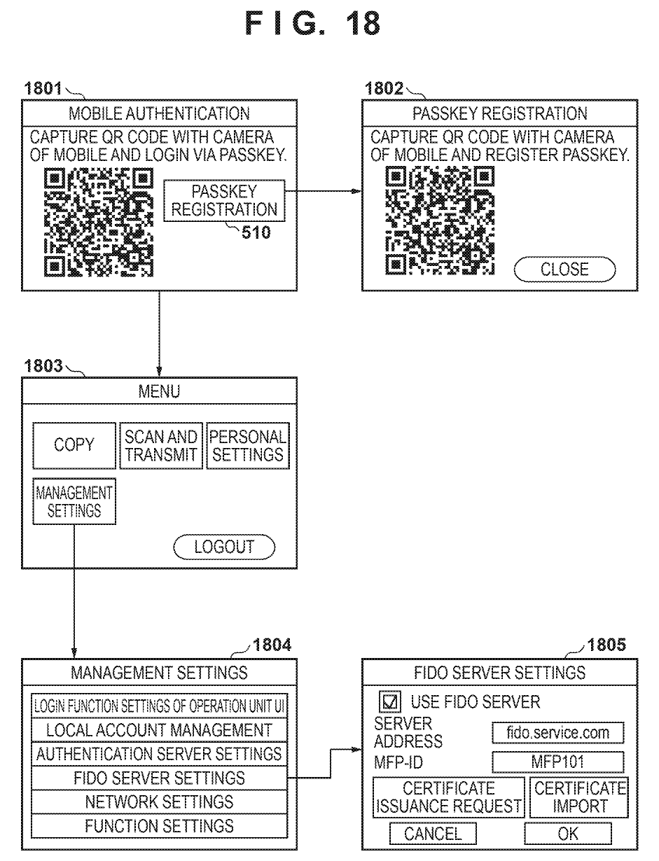

FIG. 18 is a simplified diagram illustrating a login screen displayed on the operation panel 205 and menu screens displayed after login based on this setting.

A FIDO server settings screen 1805 is a FIDO server settings screen for turning ON/OFF of the function of the MFP 101 using the FIDO server 106 and for registering information of the FIDO server 106. Also, the FIDO server settings screen 1805 provides an ID registration function for identifying the MFP, an issuing function for a client certificate used for the FIDO server to identify an MFP, a certificate import/export function, and the like. The FIDO server settings screen 1805 is displayed when “FIDO server settings” is selected on a management settings screen 1804.

A mobile authentication screen 1801 displays a QR code for passkey authentication. A URL for passkey authentication provided by the FIDO server 106 is stored in the QR code. Also, a random number can be included in the URL. The random number is issued by either the MFP 101 or the FIDO server 106, and the information of the random number is shared by the server communication unit 303 of the MFP 101 and the MFP management service 332 communicating in advance. The MFP management service 332 associates together and manages the random number and the IDs of the MFPs and connection information in such a manner that it is easy to know which random number is associated with which MFP.

The mobile authentication screen 1801 displays a “Passkey registration” button 510. When the “Passkey registration” button 510 is pressed, a passkey registration screen 1802 is displayed. A QR code for passkey registration is displayed on the passkey registration screen 1802. A URL for passkey registration provided by the FIDO server 106 is stored in the QR code. When authentication via the mobile authentication screen 1801 is successful, a menu screen 1803 is displayed. When management settings is selected on the menu screen 1803, the management settings screen 1804 is displayed.

### Passkey Registration Flow

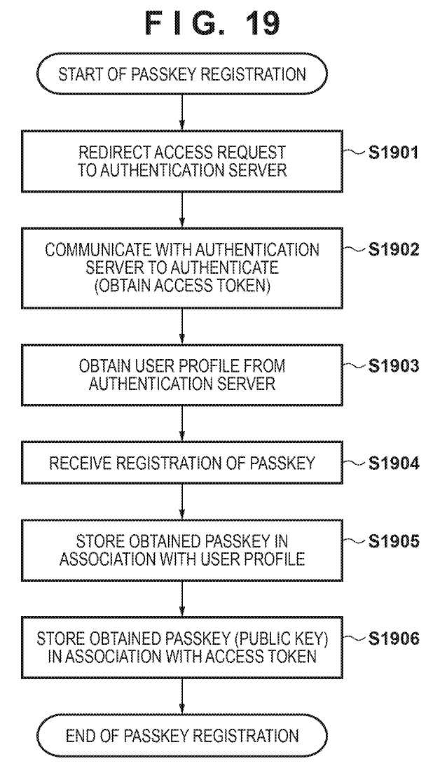

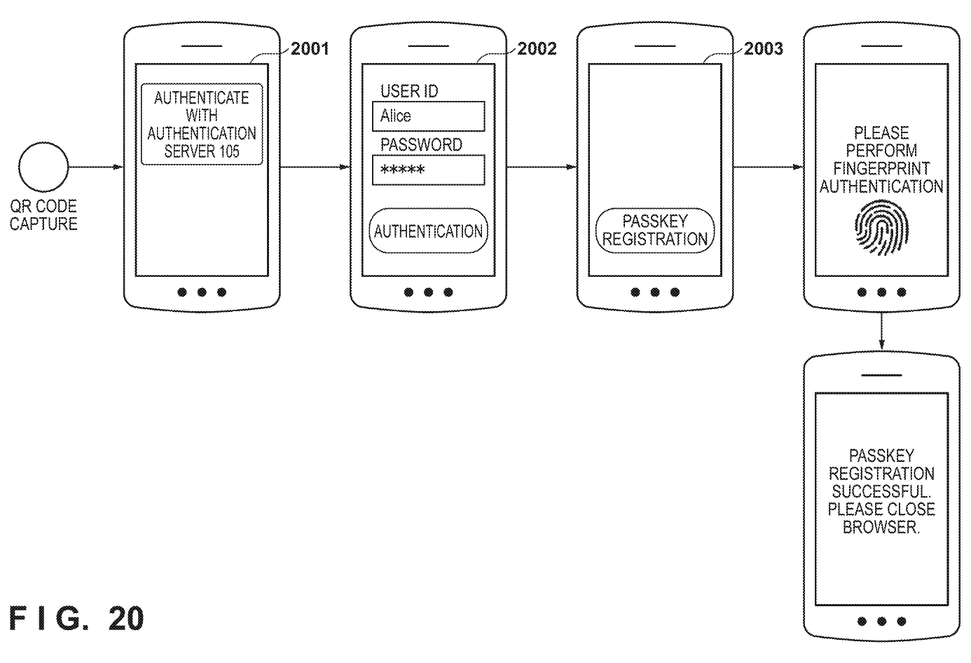

Next, passkey registration processing according to the second embodiment will be described with reference to FIG. 19. FIG. 19 is a flowchart illustrating the passkey registration processing. Unless explicitly stated, the entity that executes the flow of the present processing illustrated in FIG. 19 is the CPU 1601 of the FIDO server 106. FIG. 20 is a diagram illustrating screen transitions on the mobile terminal 102 at the time of passkey registration.

The user uses the camera function of the mobile terminal 102 they own to capture the QR code displayed on the passkey registration screen 1802, runs the web browser 314, and accesses the URL for passkey registration provided by the FIDO server 106. The FIDO service 331 of the FIDO server 106 starts the passkey registration by detecting the access to the URL for passkey registration. The FIDO service 331 that has detected access to the URL for passkey registration responds to the mobile terminal 102 with the HTML of a UI including a “Authenticate with authentication server 105” button of a screen 2001. The FIDO service 331 detects the press of the “Authenticate with authentication server 105” button on the screen 2001. The processing of FIG. 19 is started from this stage.

In S1901, the FIDO service 331 redirects the access request to the URL of the authentication server 105 for authentication/authorization of the user via an Authorization Code Grant of OAuth 2.0. To eliminate the effort of the user pressing the “Authenticate with authentication server 105” button, in a case where access to the URL for passkey registration is detected, instead of responding with an HTML screen, the access request may be redirected to the URL of the authentication server 105.

A user authentication screen 2002 provided by the authentication server 105 is displayed on the mobile terminal 102. The user inputs the user ID and password of the server account on the user authentication screen 2002. Also, in a case where multi-factor authentication is enabled, the additional input of a one-time password may also be requested (not illustrated). When user authentication is successful, an OAuth 2.0 authorization screen may be displayed (not illustrated). When authentication/authorization is successful, an access token and refresh token are transmitted to the FIDO service 331.

In S1902, the FIDO service 331 obtains the access token and refresh token as the result of authentication/authorization.

Next, in S1903, the FIDO service 331 uses the obtained access token, accesses the REST API provided by the authentication server 105, and obtains the user profile of the authenticated server account.

Next, in S1904, the FIDO service 331, as a response at the time of access token reception, transmits the HTML of a screen 2003 including a “Passkey registration” button and JavaScript of WebAuthn to the mobile terminal 102 and receives registration of a passkey. When a press of the “Passkey registration” button is detected, JavaScript is executed, and the passkey registration sequence is started. To remove the effort involved in the user pressing the “Passkey registration” button, the JavaScript may be automatically executed to start the passkey registration sequence. The passkey registration sequence includes processing similar to the processing between the mobile terminal 102 and the FIDO service 304 in S903 to S916 illustrated in FIG. 9 being executed between the mobile terminal 102 and the FIDO service 331. During this time, the screen 2003 requesting the user for biometric authentication is displayed on the mobile terminal 102.

In S1905, in response to the passkey registration sequence being successful, the FIDO service 331 associates the obtained passkey information (credential ID and public key) with the user profile obtained in S1903 and stores them in a database for storing information similar to that of the user profile table 403.

Also, in S1906, the FIDO service 331 preferably stores the access token and refresh token obtained in S1902 in association with the passkey information.

### Passkey Authentication Flow

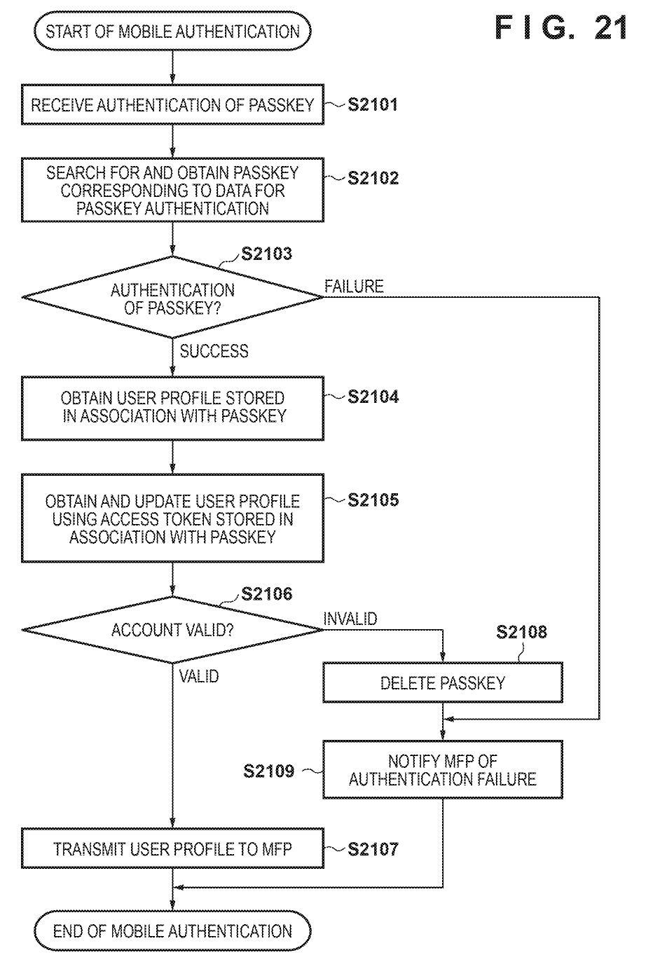

Next, passkey authentication processing according to the second embodiment will be described with reference to FIG. 21. FIG. 21 is a flowchart illustrating the passkey authentication processing. Unless explicitly stated, the entity that executes the flow of the present processing illustrated in FIG. 21 is the CPU 1601 of the FIDO server 106.

After the server communication unit 303 of the MFP 101 and the MFP management service 332 communicate in advance and share a random number, in S2101, the FIDO service 331 starts reception of passkey authentication. The user uses the camera function of the mobile terminal 102 they own to capture the QR code displayed on the mobile authentication screen 1801, runs the web browser 314, and accesses the URL for passkey authentication provided by the FIDO server 106. A random number is included in the URL for passkey authentication. By confirming in advance that the random number shared with the MFP 101 matches, the FIDO service 331 can determine that the passkey authentication request is a request to log into the MFP 101. In a case where the random number included in the URL does not match the random number shared with any of the MFPs among the plurality of MFPs, preferably, unauthorized access is determined and passkey authentication results in an error.

The passkey authentication sequence includes processing similar to the processing between the mobile terminal 102 and the FIDO service 304 in S1001 to S1012 illustrated in FIG. 10 being executed between the mobile terminal 102 and the FIDO service 331.

In S2102, the FIDO service 331 receives data (credential ID, challenge, digital signature, and the like) for passkey authentication from the mobile terminal 102. The passkey information (public key) corresponding to the credential ID obtained from the data for passkey authentication is searched for and obtained from the database storing the passkeys.

In a case where passkey obtainment is successful, in S2103, the FIDO service 331 verifies the digital signature using the public key, executes passkey authentication, and determines the result. In a case where the passkey information (public key) corresponding to the credential ID is not in the database or digital signature verification fails, passkey authentication is determined to be unsuccessful. In a case where passkey authentication is not successful, in S2109, the MFP 101 connected via WebSocket is notified that passkey authentication was not successful, and the processing ends.

In S2103, in a case where verification of the digital signature using the public key was successful, passkey authentication is determined to be successful. In this case, the processing advances to S2104.

Next, in S2104, the FIDO service 331 obtains the user profile of the server account stored in association with the passkey information successfully authenticated.

Next, in S2105, the FIDO service 331 uses the access token and refresh token stored in association with the passkey information and connects to the authentication server 105 and attempts to obtain the latest user profile. In a case where obtainment of the latest user profile is successful, the stored user profile is updated with the new information.

In S2106, the FIDO service 331 determines whether or not the server account is valid. In a case where obtainment of the latest user profile from the authentication server 105 is successful and it can be confirmed that the server account is valid, it is determined that the server account is valid. In a case where the server account has been deleted from the authentication server 105 or it can be confirmed that the server account has been deactivated from the latest user profile, it is determined that the server account is not valid.

In a case where it is determined that the server account is valid, in S2107, the FIDO service 331 transmits the user profile stored in association with the passkey information to the MFP 101 connected via WebSocket.

In a case where it is determined that the server account is not valid, in S2108, the FIDO service 331 deletes the stored passkey information and user profile. Also, in S2109, the FIDO service 331 notifies the MFP 101 connected via WebSocket that passkey authentication was not successful, and the processing ends.

The MFP 101 that has received the user profile of the server account from the FIDO server 106 uses the received user profile to execute the login processing, logs the authenticated user into the MFP 101, and displays the menu screen 503.

In the flow example described above, in S2105 and S2106, confirmation is performed relating to obtainment of the latest user profile of the authentication server 105 and the validity of the server account. However, this processing may be omitted, and in S2104, if a user profile stored in association with the passkey information can be found, this user profile may be used to execute the login processing of S2107.

### User Profile Synchronization

As another method of the FIDO server 106 updating the user profile stored in association with the passkey information, the following method is effective.

Processing similar to the processing illustrated in FIG. 14 is preferably executed by the FIDO server 106 to update the user profile. Specifically, preferably, information and credentials for accessing the authentication server 105 are pre-registered in the FIDO server 106, user profiles of a plurality of server accounts are periodically obtained from the authentication server 105, and the user profiles it stores are updated. Also, in a case where it is learnt that the server account has been deleted or invalid, the corresponding user profile is deleted.

### Effect of Second Embodiment

The second embodiment has the following effects in addition to the effects of the first embodiment.

In the first embodiment, in a case where there are a plurality of MFPs in an office, the passkey information (public key and the like) needs to be registered in each of the MFPs. To solve this problem, in the second embodiment described above, a FIDO server that cooperates with the MFP is configured separate to the MFP and authentication server. Accordingly, by registering the passkey once in the FIDO server, the same passkey can be used to log into the plurality of MFPs cooperating with the FIDO server.

### OTHER EMBODIMENTS

In the first embodiment and the second embodiment described above, an OAuth 2.0 mechanism is used to execute authentication/authorization of a server account and obtain a user profile of a server account. As an example of a mechanism other than OAuth 2.0, a mechanism specified in SAML 2.0 may be used to perform user authentication and user profile obtainment. The technology of the present disclosure is not limited to a user authentication method for a server account and a user profile obtainment method.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-063357, filed Apr. 7, 2025 which is hereby incorporated by reference herein in its entirety.

What is claimed is:

1. An image forming apparatus comprising:
at least one memory storing instructions; and
at least one processor that is in communication with the at least one memory and that, when executing the instructions, cooperates with the at least one memory to execute processing, the processing including
storing a public key and a user profile of a user in association with each other in a first memory, the public key being obtained from a terminal of the user and forming a pair with a private key held in the terminal,
executing first authentication to authenticate the user by verifying, using the public key, a digital signature received from the terminal, and
in a case where authentication of the user via the first authentication is successful, allowing the user to log into the image forming apparatus using the user profile stored in association with the public key.

2. The image forming apparatus according to claim 1, wherein the processing further includes
executing second authentication to authenticate the user using authentication information received from the terminal of the user, using an authentication server connected to the image forming apparatus,
obtaining the user profile of the user authenticated by the second authentication, from the authentication server, and
storing the user profile obtained from the authentication server and the public key obtained from the terminal, in association with each other in the second memory.

3. The image forming apparatus according to claim 2, wherein the processing further includes
obtaining an access token from the authentication server connected to the image forming apparatus,
the first memory stores the access token and the public key in association with each other, and
the obtaining includes, in a case where the authentication of the user via the verification using the public key of the digital signature received from the terminal in the first authentication is successful, obtaining the user profile of the user from the authentication server using the access token stored in association with the public key.

4. The image forming apparatus according to claim 3, wherein the processing further includes
in a case where authentication of the user using verification of the digital signature in the second authentication is successful, accessing the authentication server using the access token stored in association with the public key and determining a validity of the user profile of the user, and
the logging in includes, in a case where the user profile is determined to be valid in the determining, allowing the user to log into the image forming apparatus using the user profile.

5. The image forming apparatus according to claim 4, wherein the processing further includes
in a case where the user profile is determined to be invalid in the determining, deleting the public key and the user profile of the user stored in the first memory.

6. The image forming apparatus according to claim 1, wherein
the first memory first storing stores authentication information associated with the user, and
the processing further includes
in a case where authentication using a local account is selected, executing third authentication to authenticate the user by comparing the authentication information with authentication information received from the terminal of the user, and
in a case where authentication in the third authentication is successful, storing the user profile and the public key obtained from the terminal in association with each other by the first memory.

7. A server apparatus connected to an image forming apparatus via a network comprising:
at least one memory storing instructions; and
at least one processor that is in communication with the at least one memory and that, when executing the instructions, cooperates with the at least one memory to execute processing, the processing including
executing fourth authentication to authenticate a user using an authentication server,
obtaining a user profile of the user authenticated by the fourth authentication, from the authentication server,
storing a public key and the user profile of the user in association with each other in a second memory, the public key being obtained from a terminal of the user and forming a pair with a private key held in the terminal,
executing fifth authentication to authenticate the user by verifying, using the public key, a digital signature received from the terminal, and
in a case where authentication in the fifth authentication is successful, transmitting the user profile stored in association with the public key to the image forming apparatus.

8. The server apparatus according to claim 7, wherein
the fourth authentication includes obtaining an access token of the authenticated user from the authentication server,
the storing includes storing the public key and the access token in association with each other in the second memory, and
the obtaining includes, in a case where authentication in the fifth authentication is successful, obtaining the user profile from the authentication server using the access token stored in association with the public key.

9. The server apparatus according to claim 8, wherein the processing further includes
in a case where authentication in the fifth authentication is successful, accessing the authentication server using the access token stored in association with the public key and determining a validity of the user profile of the user authenticated in the fifth authentication, and
the transmitting includes, in a case where the user profile is determined to be valid in the determining, transmitting the user profile to the image forming apparatus.

10. The server apparatus according to claim 9, wherein the processing further includes
in a case where the user profile is determined to be invalid in the determining, deleting the public key and the user profile of the user stored in the second memory.

11. A non-transitory computer-readable storage medium storing a program that causes a computer to execute processing when loaded and executed on the computer, the processing including:
storing a public key and a user profile of a user in association with each other in a memory, the public key being obtained from a terminal of the user and forming a pair with a private key held in the terminal,
executing first authentication to authenticate the user by verifying, using the public key, a digital signature received from the terminal, and
in a case where authentication of the user in the first authentication is successful, allowing the user to log into the computer using the user profile stored in association with the public key.

12. A non-transitory computer-readable storage medium storing a program that causes a computer to execute processing when loaded and executed on the computer, the processing including:
executing fourth authentication to authenticate a user, using an authentication server,
obtaining a user profile of the user authenticated by the fourth authentication from the authentication server,
storing a public key and the user profile of the user in association with each other in a memory, the public key being obtained from a terminal of the user and forming a pair with a private key held in the terminal,
executing fifth authentication to authenticate the user by verifying, using the public key, a digital signature received from the terminal, and
in a case where authentication in the fifth authentication is successful, transmitting the user profile stored in association with the public key to the computer.

13. A control method for an image forming apparatus including a memory that stores a public key and a user profile of a user in association with each other, the public key being obtained from a terminal of the user and forming a pair with a private key held in the terminal, the control method comprising:
executing first authentication to authenticate the user by verifying, using the public key, a digital signature received from the terminal; and
in a case where authentication of the user in the first authentication is successful, allowing the user to log into the image forming apparatus using the user profile stored in association with the public key.

14. The control method for an image forming apparatus according to claim 13, further comprising:
executing second authentication to authenticate the user using authentication information received from the terminal of the user, using an authentication server connected to the image forming apparatus;
obtaining the user profile of the user authenticated by the second authentication from the authentication server; and
storing the user profile obtained from the authentication server and the public key obtained from the terminal in association with each other in the memory.

15. The control method for an image forming apparatus according to claim 13, wherein
the memory stores authentication information associated with the user, and
the control method for an image forming apparatus further comprises:
in a case where authentication using a local account is selected, executing third authentication to authenticate the user by comparing the authentication information with authentication information received from the terminal of the user, and
in a case where authentication in the third authentication is successful, storing the user profile and the public key obtained from the terminal in association with each other in a second memory.

16. A control method for a server apparatus connected to an image forming apparatus via a network, the control method comprising:
executing fourth authentication to authenticate a user, using an authentication server;
obtaining a user profile of the user authenticated by the fourth authentication from the authentication server;
storing a public key and the user profile of the user in association with each other in a memory, the public key being obtained from a terminal of the user and forming a pair with a private key held in the terminal;
executing fifth authentication to authenticate the user by verifying, using the public key, a digital signature received from the terminal; and
in a case where authentication in the fifth authentication is successful, transmitting the user profile stored in association with the public key to the image forming apparatus.
